(19) United States
(12) Patent Application Publication
(10) Pub. No.: US 2026/0187863 A1
(43) Pub. Date: Jul. 2, 2026

(54) COLOR RECOMMENDATION AND REAL-WORLD OBJECT COLOR UPDATE

(71) Applicant: INTERNATIONAL BUSINESS MACHINES CORPORATION, ARMONK, NY (US)

(72) Inventors: Dhruv Khurana, Marietta, GA (US); Radha Mohan De, Howrah (IN)

(21) Appl. No.: 19/007,896

(22) Filed: Jan. 2, 2025

(51) Int. Cl. G06T 11/00; G06F 40/30; G06V 20/70

(52) U.S. Cl. CPC G06T 11/10; G06F 40/30; G06V 20/70

(57) ABSTRACT

Provided are techniques for color recommendation and real-world object color update. Initial inputs are received with a request to identify a desired color for a real-world object, where the initial inputs include text, images, and a descriptive context. A global collection of text is created from the text, the images, and the descriptive context. Color search keywords are generated from the global collection of text. A search is executed against a knowledge base that compares the color search keywords to tags of colors in the knowledge base to identify one or more colors. The one or more colors are displayed. In response to receiving selection of a color from the one or more colors, the real-world object is updated with the selected color.

### BACKGROUND

Embodiments of the invention relate to color recommendation and real-world object color update with auto-tagging from user intention.

Research indicates that human eyes are able to distinguish between 1-10 million colors out of approximately 16.7 million colors possible from mixing Red Green Blue (RGB) colors. It is often challenging for a user to pick a color based on referencing real-world objects (e.g., plants, cars, clothes, etc.).

### SUMMARY

In accordance with certain embodiments, a computer-implemented method comprising operations is provided for color recommendation and real-world object color update. In such embodiments, initial inputs are received with a request to identify a desired color for a real-world object, where the initial inputs include text, images, and a descriptive context. A global collection of text is created from the text, the images, and the descriptive context. Color search keywords are generated from the global collection of text. A search is executed against a knowledge base that compares the color search keywords to tags of colors in the knowledge base to identify one or more colors. The one or more colors are displayed. In response to receiving selection of a color from the one or more colors, the real-world object is updated with the selected color.

In accordance with other embodiments, a computer program product one or more computer-readable storage media and program instructions stored on the one or more computer-readable storage media to perform operations for color recommendation and real-world object color update. In such embodiments, initial inputs are received with a request to identify a desired color for a real-world object, where the initial inputs include text, images, and a descriptive context. A global collection of text is created from the text, the images, and the descriptive context. Color search keywords are generated from the global collection of text. A search is executed against a knowledge base that compares the color search keywords to tags of colors in the knowledge base to identify one or more colors. The one or more colors are displayed. In response to receiving selection of a color from the one or more colors, the real-world object is updated with the selected color.

In accordance with yet other embodiments, a computer system comprises a processor set; one or more computer-readable storage media; and program instructions stored on the one or more computer-readable storage media to cause the processor set to perform operations for color recommendation and real-world object color update. In such embodiments, initial inputs are received with a request to identify a desired color for a real-world object, where the initial inputs include text, images, and a descriptive context. A global collection of text is created from the text, the images, and the descriptive context. Color search keywords are generated from the global collection of text. A search is executed against a knowledge base that compares the color search keywords to tags of colors in the knowledge base to identify one or more colors. The one or more colors are displayed. In response to receiving selection of a color from the one or more colors, the real-world object is updated with the selected color.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for a color update system in accordance with certain embodiments.

FIGS. 3A and 3B illustrate, in a flowchart, operations for color recommendation and real-world object color update with auto-tagging from user intention in accordance with certain embodiments.

FIG. 4 illustrates, in a flowchart, operations for recommending a color and updating a real-world object with that color in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

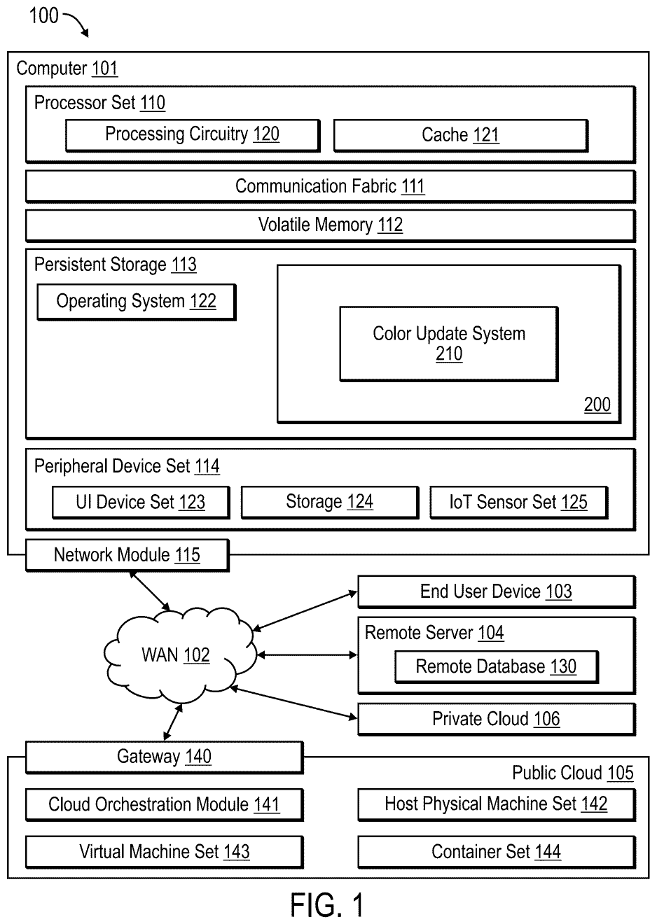

Computing environment 100 of FIG. 1 contains an example of an environment for the execution of at least some of the computer code involved in performing the inventive methods, such as a color update system 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

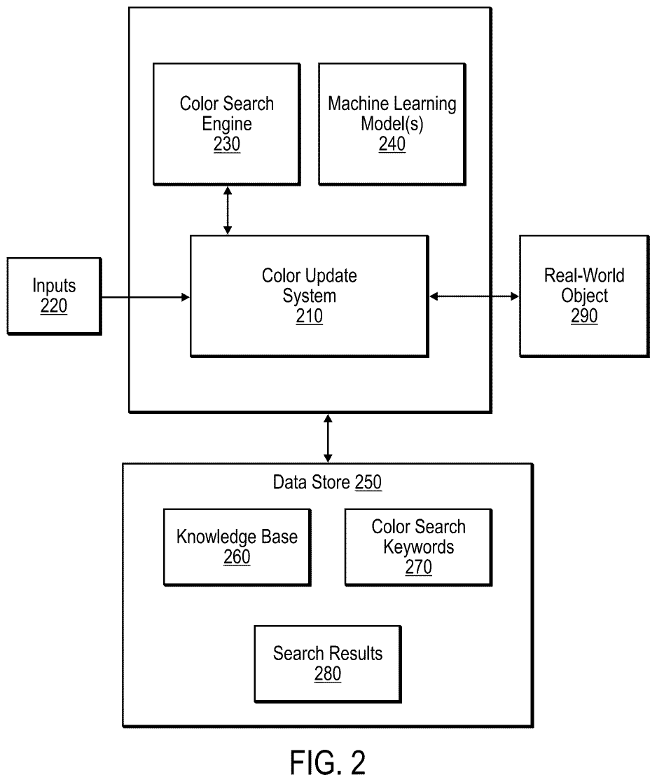

FIG. 2 illustrates a computing environment for the color update system 210 in accordance with certain embodiments. The color update system 210 receives inputs 220. The color update system 210 is connected to a color search engine 230, one or more machine learning models 240, and to a data store 250. The data store 250 includes a knowledge base 260, color search keywords 270, and search results 280.

In certain embodiments, the color update system 210 receives the inputs 220 from a user regarding a color. The inputs 220 may express the user intention (i.e., what one or more colors the user intends to request) with texts, phrases, contents, images, etc. The input may be described as hints as to what particular color the user is looking for. The color update system 210 determines the user intention through the inputs 220 and focuses on finding one or more colors to recommend. The colors may be simple colors and/or complex colors. A simple color may be one that refers to the color of a real-world object (e.g., rose, bottle green, sky blue, etc.). A complex color may be difficult to express with reference to one or more real-world objects, and, instead, may be described with multiple hints (e.g., color of sunset, color of color of water in a stream or a lake, etc.).

In certain embodiments, the color update system 210 translates a user intention into color search keywords 270 for color recommendations. Then, the color update system 210 issues a search request using the color search keywords 270 to the color search engine 230. The color search engine 230 recommends one or more simple and/or complex color shades.

In certain embodiments, the user also indicates a real-world object 290 of the desired color and a task as part of the inputs 220. For example, the user may ask for a color to change lights in a room (e.g., changing lights in a room for a wedding to a champagne color), may ask to change the color in an image (e.g., changing the color of dried, brown grass in a picture to spring green), may ask to change the color of a computer screen (e.g., changing from a default blue to a sky blue color), may ask for an item for purchase (e.g., finding a sweater in that is the color of a sunset), etc. Then, the color update system 210 also considers the real-world object of the user's choice when recommending one or more colors. In this manner, the color update system 210 takes into consideration the spatiotemporal and sociocultural diversity of search inputs from different users.

The color update system 210 recommends one or more colors based on user intention of a user based on the inputs 220 of text, images, a description of context, and the real-world object for the desired color. Moreover, the color update system 210 collects a satisfaction score from the user to augment confidence of the recommendation. In certain embodiments, the color update system 210 suggests tags generated from Artificial Intelligence (AI) using a machine learning model 240 for the one or more recommended colors, and the user may vote on the best fit tag/name for the user's chosen one or more colors. In addition, the user may customize a tag/name. The color update system 210 may be linked to an online system to select and purchase a customized color for user selected articles such as: clothing, car paint, décor, furniture, etc. The online system may be an e-commerce system. The online system may be a portal for choosing one or more colors for interior decoration and purchasing items of those one or more colors.

In certain embodiments, the color update system 210 recommends one or more colors by extracting information from user intention based on text, images, and a description of context.

The knowledge base 260 stores colors, with each of the colors having a name and tags indicating one or more real-world objects, topics, and/or concepts. A topic may be described as a subject (e.g., a wedding gown for a first person). A concept may not be expressible in a single word or sentence, and may contain multiple topics (e.g., dress code for a second person to attend an independence day celebration of a first country that is held in a second country, which would reflect the mix of culture of the first country and the second country). For example, the color “champagne” may be associated with drapes (real-world object), weddings (topic), and events (concept).

In certain embodiments, the knowledge base 260 is trained from multiple sources of information such as: encyclopedias, magazines, news articles, social media, etc. In certain embodiments, the color update system 210 uses a machine learning model to tag and/or name the colors based on the color search keywords 270. By adding these tags or names, the color update system 210 may popularize or pioneer these colors, which may make those colors go viral. Also, by adding tags or names to the colors, the color update system 210 may identify unique colors. The knowledge base 260 may be referred to as a data dictionary knowledge base.

In certain embodiments, the color update system 210 builds the knowledge base 260. The color update system 210 scrapes publicly available textual data from sources such as: encyclopedias, magazines, news articles, social media, etc. The color update system 210 maps keywords, phrases, facts, real-world objects, incidents, current affairs, etc. with color codes. The color update system 210 uses a Reinforcement Learning model (i.e., a machine learning model) to validate matches and correct any incorrect information or misinformation. For example, the color update system 210 maps symmetrical data points X1, X2, X3 to color code C1, and if Context Z1 is suggested, then the RL model prevents Z1 from being mapped to color code C1. Symmetrical data may be described as data points that share common elements/attributes. The color update system 210 stores the mappings/matches in the knowledge base 260 (e.g., an unstructured database).

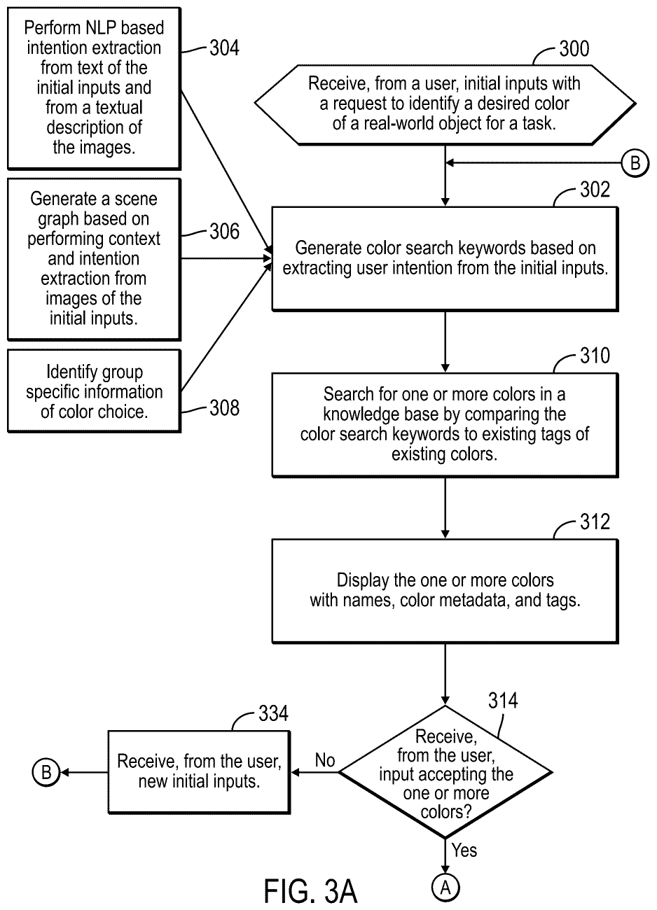

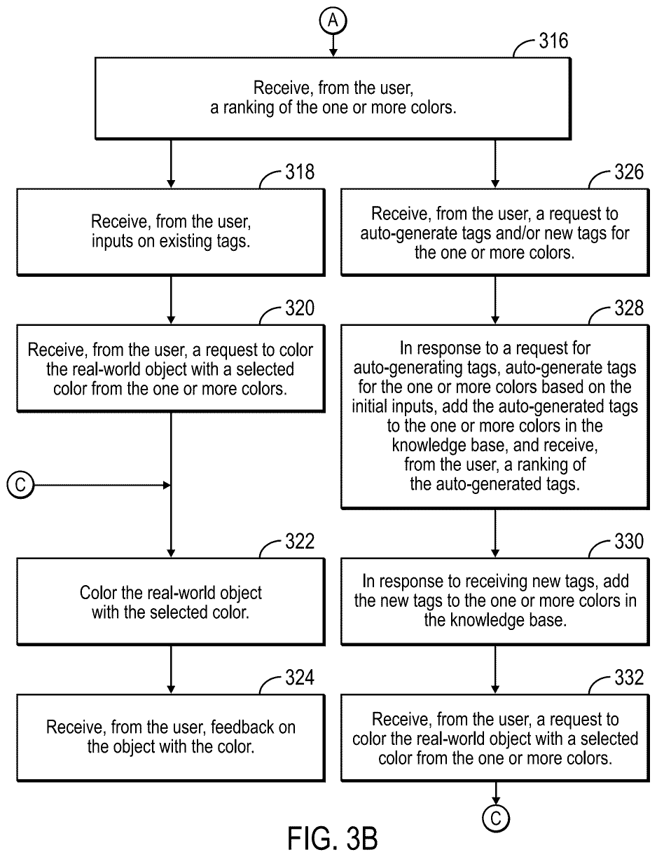

FIGS. 3A and 3B illustrate, in a flowchart, operations for color recommendation and real-world object color update with auto-tagging from user intention in accordance with certain embodiments. Control begins at block 300 with the color update system 210 receiving, from a user, initial inputs with a request to identify a desired color of a real-world object for a task. The initial inputs include text (e.g., words or phrases), images, and/or a descriptive context. The descriptive context may include spatiotemporal inputs (e.g., location and time), images, and marked images. The marked images are marked by the user to indicate portions important to the user (e.g., a portion of the sky circled in the image). The descriptive context may also include information about groups the user belongs to (e.g., a car group, a book club, a local social group, etc.). The task may be to change lights in a room to the desired color, to change the color in an image, to purchase a sweater of the desired color, etc. The descriptive context may additionally include information about culture, geography, population, an activity, etc.

In block 302, the color update system 210 generates color search keywords based on extracting user intention from the initial inputs. In certain embodiments, the color update system 210 receives additional information from the processing of blocks 304, 306, and 308.

In block 304, the color update system 210 performs Natural Language Processing (NLP) based intention extraction from the text of the initial inputs and from a textual description of the images. That is, the color update system 210 performs semantic analysis on corpus of the text (e.g., user provided words or phrases and a textual description generated by image captioning) to determine the user intention. Image captioning may be described as processing of the images to generate the textual description of the images. In certain embodiments, the color update system 210 determines the user intention through analyzing the array of user hints to find the color, in terms of their mutual relations, semantic correlations, and finally, ontological relations among various pieces of user hints with text/topic/concept/image, etc.

In block 306, the color update system 210 processes images to generate scene graphs based on performing context and intention extraction from images of the initial inputs. A scene graph represents the images, with each scene graph encoding the real-world objects (e.g., car, sweater) as nodes connected via pairwise relationships (e.g., purchasing) as edges. In addition, the color update system 210 Image captioning on image data to generate textual description of images

In block 308, the color update system 210 identifies group specific information from the groups of the descriptive context. The group specific information may indicate preferred colors for the group (e.g., a local social club uses green and blue in communications).

Then, the color update system 210 receives the NLP based intention extraction (block 304), the scene graphs (block 306), and the group specific information (block 308), which are used to generate the color search keywords. In certain embodiments, the color update system 210 creates a global collection of text based on the user input of text and images. The color update system 210 uses a neural network (e.g., a Contrastive Language-Image Pre-Training (CLIP) neural network) to extract text from images, and this text is added to the global collection of text. From this global collection, the color update system 210 extracts keywords using techniques of keyword extraction and topic modeling. For example, the color update system 210 may generate keywords such as: Country-flag-orange-in 1947 versus oranges-fruit-found-in-Florida-in 2023; red-color-dress-worn-by-Country-brides-on-wedding day versus red-firetrucks-in-USA vs red-colored-dress-worn-on-Holiday; etc.

In block 310, the color update system 210 searches for one or more colors in the knowledge base by comparing the color search keywords to existing tags of existing colors in the knowledge base. In certain embodiments, the color update system 210 searches from a historic search pattern. That is, if the set of user inputs matches the pattern of earlier search inputs corresponding to earlier search results, then the color update system 210 may use the earlier results (from the previous (historic) search results). In certain embodiments, if no colors are found by comparing the color search keywords to existing tags, the color update system 210 searches for one or more colors without tags as the colors have words/information/data associated with them during pre-training. In certain embodiments, the color update system 210 invokes the color search engine 230 to perform the search against the knowledge base.

In block 312, the color update system 210 displays (e.g., on a computer screen) the one or more colors with names, color metadata, and tags. The color metadata may be RGB data that indicate the amount of each color of red, green, and blue used for that shade. In certain embodiments, in addition to or instead of the RGB data, the color update system 210 provides Hue, Saturation, and Lightness (HSL) codes and/or HEX color values. In certain embodiments, the color update system 210 presents these colors in descending order of maximum to minimum match and lists a number of occurrences and/or popularity of each of the colors.

In block 314, the color update system 210 determines whether input from the user indicates acceptance of the one or more colors. If the one or more colors are accepted, processing continues from block 314 (FIG. 3A) to block 316 (FIG. 3B), otherwise, processing continues to block 334. In certain embodiments, the user indicates like, dislike or neutral for the one or more colors to indicate which, if any, of the one or more colors are accepted.

In block 316, the color update system 210 receives, from the user, a ranking of the one or more colors. The color update system 210 may use this ranking to improve future searches. The ranking may indicate preference of the one or more colors ranging from a maximum preference to a minimum preference to match the user intention. From block 316, the processing of blocks 318-324 and the processing of blocks 326-332 may both occur, either in parallel or sequentially.

In block 318, the color update system 210 receives, from the user, inputs on existing tags of the one or more colors. In certain embodiments, the inputs on each of the existing tags may indicate like, dislike or neutral. In certain other embodiments, the inputs on each of the existing tags provide a ranking for that tag. In certain embodiments, the color update system 210 displays the existing tags of the one or more colors ordered by popularity.

In block 320, the color update system 210 receives, from the user, a request to color the real-world object with a selected color from the one or more colors. This is an example of a task, but, in other embodiments, other tasks may be requested.

In block 322, the color update system 210 colors the real-world object with the selected color. Coloring the real-world object refers to changing the color of the real-world object to the selected color. For example, the color update system 210 may change the color of a light (i.e., the real-world object) in a room to the selected color.

In block 324, the color update system 210 receives, from the user, feedback on the real-world object with the color. The feedback may indicate like, dislike or neutral. The color update system 210 may use this feedback to improve future searches.

In block 326, the color update system 210 receives, from the user, a request to auto-generate tags and/or new tags for the one or more colors.

In block 328, the color update system 210, in response to a request for auto-generating tags, auto-generates tags for the one or more colors based on the initial inputs, adds the auto-generated tags to the one or more colors in the knowledge base, and receives, from the user, a ranking of the auto-generated tags. The auto-generated tags reflect the user intention based on the initial inputs. The color update system 210 may use this ranking to improve future searches. In certain embodiments, the color update system 210 auto-generates a textual tag by applying semantic analysis on the color search keywords.

In block 330, the color update system 210, in response to receiving new tags, adds the new tags to the one or more colors in the knowledge base. The new tags may be ranked.

In certain embodiments, the auto-generated tags or the new tags from the user are added to existing colors that currently do not have tags. Thus, in this manner, adding tags to non-tagged colors improves future searches.

In block 332, the color update system 210 receives, from the user, a request to color the real-world object with a selected color from the one or more colors. This is an example of a task, but, in other embodiments, other tasks may be requested. From block 332, processing continues to block 322.

In block 334, the color update system 210 receives, from the user, new initial inputs to identify the desired color for the task and processing continues to block 302 to perform another search for one or more new colors. In this manner, the color update system 210 enables a user who is not satisfied with the displayed one or more colors to provide more information so that the color update system 210 better understands the user intention.

By learning from user inputs and feedback, the color update system 210 is continuously learning to improve future recommendations of one or more colors.

Merely to enhance understanding of embodiments, an example is provided. In this example, a user wants to find the best fitting color hat to wear for a holiday in a particular country. The user provides an image of an elder brother wearing a suit and an image of a desired style hat to indicate user intention. The user also adds text of: holiday of a particular country, celebrated in Spring, etc.

The color update system 210 processes the inputs to recommend one or more best fitting colors for the hat. The color update system 210 determines the color of the input images and sub-images. The color update system 210 finds the most used colors of the selected real-world object (hat) and the given description of the context using a machine learning model. The color update system 210 recommends one or more colors for the hat. The user selects one or more of these colors. The color update system 210 presents an indicative picture of the hat (if image for hat is supplied) to the user. The user indicates a vote for each of the colors. The vote may be a range (e.g., 1-10 or a-z). For the color with the highest vote, the color update system 210 then recommends tags (e.g., hat-color-Country-holiday, hat-color, etc. The color update system 210 adds the tags to the knowledge base for use in future searches. The color update system 210 then changes the color of the image of the desired hat to enable the user to better envision the desired color on the real-world object. In addition, the color update system 210 automatically works with an e-commerce system to locate a hat of that style and color.

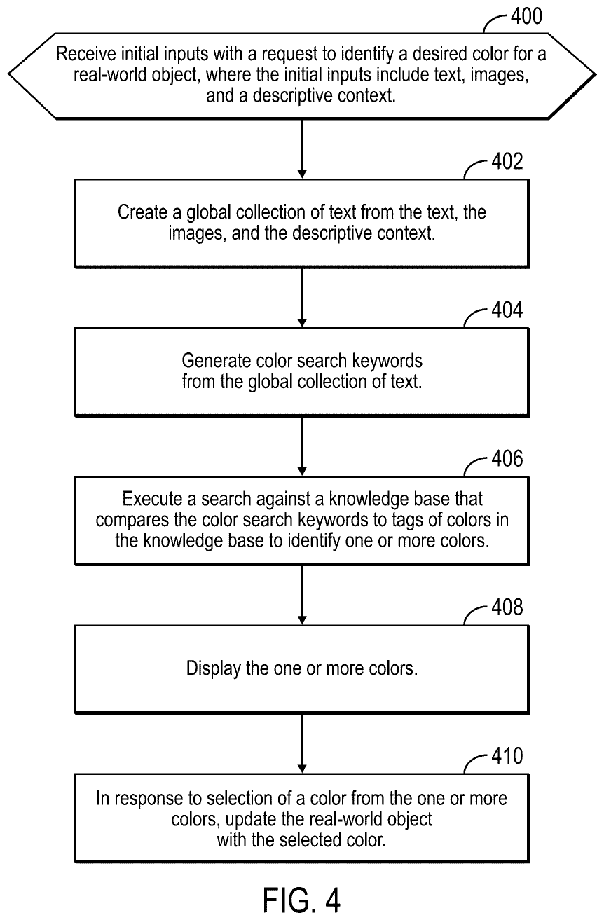

FIG. 4 illustrates, in a flowchart, operations for recommending a color and updating a real-world object with that color in accordance with certain embodiments.

Control begins at block 400 with the color update system 210 receiving initial inputs with a request to identify a desired color for a real-world object, where the initial inputs include text, images, and a descriptive context. In block 402, the color update system 210 creates a global collection of text from the text, the images, and the descriptive context. In block 404, the color update system 210 generates color search keywords from the global collection of text. In block 406, the color update system 210 executes a search against a knowledge base that compares the color search keywords to tags of colors in the knowledge base to identify one or more colors. In block 408, the color update system 210 displays the one or more colors on a computer screen (e.g., of a smart phone, a desktop computer, etc.).

In block 410, the color update system 210, in response to selection of a color from the one or more colors, updates the real-world object with the selected color. Updating the real-world object refers to changing the color of the real-world object to the selected color. For example, the color update system 210 may change lights in a room to the selected color, change the color in an image to the selected color, etc.

In certain embodiments, the color update system 210 translates user intention into color search keywords for color recommendations into a color search engine, where the color search engine further recommends one or more color shades. The color update system 210 generates a knowledge base of topics, concepts, and real-world objects associated with colors. The color update system 210 trains the knowledge base from various sources of information, including encyclopedias, magazines, news articles, and social media. The color update system 210 receives text, phrases, and images with marked portions from a user expressing intention to search for colors.

In certain embodiments, the color update system 210 generates the color search keywords from a corpus generated using input from the trained knowledge base and the received text, the received phrases, and the received images, where generating the color search keywords further includes performing image captioning on image data to generate a textual description of the images, semantic analysis on the corpus of the text data to determine the intended color, identifying user demographic, sociocultural, spatiotemporal information, population, and geography.

The color update system 210 may identify the colors in the corpus by comparing the color search keywords with previously tagged colors, where identifying the colors further includes auto-generating a textual tag by applying semantic analysis on the corpus. In response to not identifying a color match to the previously tagged colors, the color update system 210 searches through non-tagged colors (i.e., colors without tags). This may be done with the color update system 210 executing a new search against the knowledge base that compares the color search keywords to data associated with non-tagged colors.

The color update system 210 recommends a set of colors and the respective RGB, HEX, and HSL codes and presents the set of colors in descending order of maximum to minimum match and lists a number of occurrences and popularity of each of the colors.

In certain embodiments, the color update system 210 receives user votes for the set of colors to determine whether the user is content with the set of colors. In response to identifying that the user is not satisfied with the set of colors, the color update system 210 gathers more information to better understand the user's intention.

Moreover, the color update system 210 recommends a textual tag by presenting the previously generated tags of a color ordered by popularity.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
receiving initial inputs with a request to identify a desired color for a real-world object, wherein the initial inputs comprise text, images, and a descriptive context;
creating a global collection of text from the text, the images, and the descriptive context;
generating color search keywords from the global collection of text;
executing a search against a knowledge base that compares the color search keywords to tags of colors in the knowledge base to identify one or more colors;
displaying the one or more colors; and
in response to receiving selection of a color from the one or more colors, updating the real-world object with the selected color.

2. The computer-implemented method of claim 1, wherein the operations further comprise:
executing a new search against the knowledge base that compares the color search keywords to data associated with non-tagged colors.

3. The computer-implemented method of claim 1, wherein the operations further comprise:
training the knowledge base from multiple sources of information comprising encyclopedias, magazines, news articles, and social media.

4. The computer-implemented method of claim 1, wherein the operations further comprise:
performing image captioning on the images to generate a textual description of the images for the global collection of text; and
performing semantic analysis on the global collection of text to understand user intention of the desired color.

5. The computer-implemented method of claim 1, wherein the operations further comprise:
auto-generating new tags for the selected color; and
receiving additional tags from a user for the selected color.

6. The computer-implemented method of claim 1, wherein the operations further comprise:
receiving new initial inputs for another search for one or more new colors.

7. The computer-implemented method of claim 1, wherein the operations further comprise:
receiving input from a user ranking the one or more colors.

8. A computer program product comprising:
one or more computer-readable storage media; and
program instructions stored on the one or more computer-readable storage media to perform operations comprising:
receiving initial inputs with a request to identify a desired color for a real-world object, wherein the initial inputs comprise text, images, and a descriptive context;
creating a global collection of text from the text, the images, and the descriptive context;
generating color search keywords from the global collection of text;
executing a search against a knowledge base that compares the color search keywords to tags of colors in the knowledge base to identify one or more colors;
displaying the one or more colors; and
in response to receiving selection of a color from the one or more colors, updating the real-world object with the selected color.

9. The computer program product of claim 8, wherein the operations further comprise:
executing a new search against the knowledge base that compares the color search keywords to data associated with non-tagged colors.

10. The computer program product of claim 8, wherein the operations further comprise:
training the knowledge base from multiple sources of information comprising encyclopedias, magazines, news articles, and social media.

11. The computer program product of claim 8, wherein the operations further comprise:
performing image captioning on the images to generate a textual description of the images for the global collection of text; and
performing semantic analysis on the global collection of text to understand user intention of the desired color.

12. The computer program product of claim 8, wherein the operations further comprise:
auto-generating new tags for the selected color; and
receiving additional tags from a user for the selected color.

13. The computer program product of claim 8, wherein the operations further comprise:
receiving new initial inputs for another search for one or more new colors.

14. The computer program product of claim 8, wherein the operations further comprise:
receiving input from a user ranking the one or more colors.

15. A computer system comprising:
a processor set;
one or more computer-readable storage media; and
program instructions stored on the one or more computer-readable storage media to cause the processor set to perform operations comprising:
receiving initial inputs with a request to identify a desired color for a real-world object, wherein the initial inputs comprise text, images, and a descriptive context;
creating a global collection of text from the text, the images, and the descriptive context;
generating color search keywords from the global collection of text;
executing a search against a knowledge base that compares the color search keywords to tags of colors in the knowledge base to identify one or more colors;
displaying the one or more colors; and
in response to receiving selection of a color from the one or more colors, updating the real-world object with the selected color.

16. The computer system of claim 15, wherein the operations further comprise:
executing a new search against the knowledge base that compares the color search keywords to data associated with non-tagged colors.

17. The computer system of claim 15, wherein the operations further comprise:
training the knowledge base from multiple sources of information comprising encyclopedias, magazines, news articles, and social media.

18. The computer system of claim 15, wherein the operations further comprise:
performing image captioning on the images to generate a textual description of the images for the global collection of text; and
performing semantic analysis on the global collection of text to understand user intention of the desired color.

19. The computer system of claim 15, wherein the operations further comprise:
auto-generating new tags for the selected color; and
receiving additional tags from a user for the selected color.

20. The computer system of claim 15, wherein the operations further comprise:
receiving new initial inputs for another search for one or more new colors.
